(19) United States
(12) Patent Application Publication
(10) Pub. No.: US 2004/0009419 A1
(43) Pub. Date: Jan. 15, 2004

(54) Electrophotographic photoreceptor having both excellent mechanical strength and electrical properties and electrophotographic imaging apparatus using the same

(75) Inventors: Saburo Yokota, Gyeonggi-do (KR); Hwan-koo Lee, Gyeonggi-do (KR); Nam-jeong Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-City (KR)

(21) Appl. No.: 10/459,720

(22) Filed: Jun. 12, 2003

(30) Foreign Application Priority Data
Jun. 17, 2002 (KR) 2002-33723

(51) Int. Cl. G03G 5/05

(52) U.S. Cl. 430/59.6; 430/96; 399/159

(57) ABSTRACT

An electrophotographic photoreceptor includes a photosensitive layer including a layer having at least one of a binder resin that includes a polymer compound and a hole transport material that includes a low-molecular weight compound, on an electrically conductive substrate, wherein the polymer compound is a polyester resin having a biphenylfluorene unit having a predetermined structure in a main chain, and the low-molecular weight compound is a stilbene compound having a predetermined structure. The electrophotographic photoreceptor according to the present invention has effective electrostatic properties and mechanical strength.

### CROSS-REFERENCE TO RELATED APPLICATIONS

This application claims the benefit of Korean Application No. 2002-33723, filed Jun. 17, 2002, in the Korean Intellectual Property Office, the disclosure of which is incorporated herein by reference.

### BACKGROUND OF THE INVENTION

1. Field of the Invention

The present invention relates to an electrophotographic photoreceptor, and more particularly, to an electrophotographic photoreceptor having both high durability and good electrical properties, and an electrophotographic imaging apparatus using the same.

2. Description of the Related Art

In general, an electrophotographic photoreceptor includes a photosensitive layer including a charge generating material, charge transport material and a binder resin, formed on an electrically conductive substrate. In recent years, functionally separated photoreceptors having a laminated structure in which a charge generating layer and a charge transport layer are laminated, have been widely used as photosensitive layers. As the binder resin for use in the charge transport layer, polycarbonate resins, acryl resins, polyester resins, polysulfone resins or polystyrene-based resins are generally used. Specifically, the polycarbonate resins are most commonly used because of an effective electrically insulating property and high mechanical strength, and the high compatibility with charge transport materials of a low-molecular weight compound. However, since the polycarbonate resins have a poor adhesive force to a metal substrate, low heat resistance and insufficient durability, research into new resins to replace the conventional polycarbonate resins is underway.

In recent years, much attention has been paid to a polyester resin having a fluorene backbone in a main chain, called a cardo polymer, as disclosed in U.S. Pat. No. 4,387,209, JP 64-001723 and JP 06-049186, because of its heat resistance, high mechanical strength, effective optical properties and the like. Also, attempts at using the cardo polymer as a binder resin for an electrophotographic photoreceptor, have been proposed, as disclosed in JP 05-297601, 07-281456, 10-020515, 2000-327757 and the like.

However, for example, as disclosed in JP 10-020515, it has been noted that a photoreceptor comprising such a polymer as the binder resin of the photosensitive layer shows the tendency of larger dark decay and lower sensitivity. To compensate for the problems, mixtures of the polymer and other polymers as a binder resin as disclosed in above 10-020515 patent were proposed. But, such a proposed method has the disadvantage that the original advantages of a cardo polymer are weakened due to characteristics of the other binder resins mixed therewith.

To realize an electrophotographic photoreceptor which exhibits effective properties of a cardo polymer without impairing intrinsic properties thereof, the inventors have studied extensively potential compositions of a photoreceptor and have found out that the use of specific stilbene compounds as a hole transport material resulted in a photoreceptor having effective electrical properties without a reduction in the physical and chemical advantages of a cardo polymer. The present invention is based on this finding.

### SUMMARY OF THE INVENTION

Additional aspects and/or advantages of the invention are set forth in part in the description which follows and, in part, will be obvious from the description, or may be learned by practice of the invention.

The present invention provides an electrophotographic photoreceptor comprising a photosensitive layer including a layer comprising at least one of a binder resin comprising a polymer compound and a hole transport material comprising a low-molecular weight compound, on an electrically conductive substrate, wherein the polymer compound is a polyester resin having biphenylfluorene unit represented by Formula 1 in the main chain, and the low-molecular weight compound is a stilbene compound represented by Formula 2:

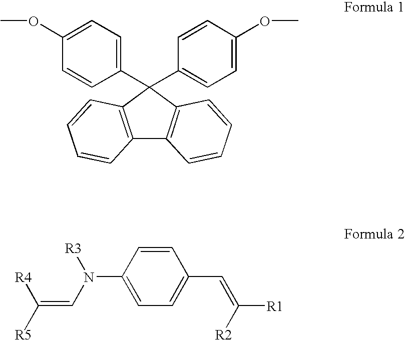

wherein in Formula 1, a hydrogen atom of an aromatic ring may be substituted by an arbitrary substituent; and in Formula 2, R1 through R5 are independently a hydrogen atom, a C1˜C30 substituted or unsubstituted alkyl group, a C6˜C30 substituted or unsubstituted aryl group, a C1˜C30 substituted or unsubstituted alkoxy group, or a C8˜C30 substituted or unsubstituted styryl group, and the hydrogen atom in the aromatic ring may be substituted by an arbitrary substituent.

The substituent in the aromatic ring of Formula 1 may be any one that may be substituted with the hydrogen atom, for example, a halogen atom, nitro, cyano, amino, alkyl, alkoxy, aryl, styryl and the like.

The substituents in R1 through R5 of Formula 2 and the aromatic ring may also be any one that may be substituted with the hydrogen atom, for example, a halogen atom, nitro, cyano, amino, alkyl, alkoxy, aryl, styryl and the like.

The photosensitive layer may have a dual layer structure of a charge transport layer containing the binder resin and the hole transport material and a charge generating layer, respectively.

The layer containing the binder resin and the hole transport material may further include a charge generating material.

The layer containing the binder resin and the hole transport material may further include an electron transport material.

The polyester resin is preferably a copolymer having at least two structural units selected from the following units represented by Formulas 3, 4 and 5:

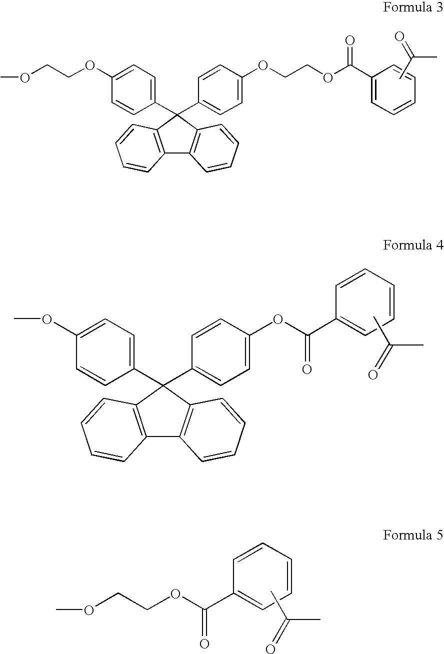

The proportion of the stilbene compound contained in the photosensitive layer is preferably in the range of 10˜60 parts by weight.

In accordance with another aspect of the present invention, an electrophotograhic imaging apparatus may use the electrophotographic photoreceptor.

### BRIEF DESCRIPTION OF THE DRAWINGS

These and/or other aspects and advantages of the invention will become apparent and more readily appreciated from the following description of the embodiments taken in conjunction with the accompanying drawings, of which:

FIG. 1 is a block diagram illustrating (not to scale) an electrophotographic photoreceptor comprising a single layer type photosensitive layer installed on a substrate in accordance with an embodiment of the present invention.

FIG. 2 is a block diagram illustrating (not to scale) an electrophotographic photoreceptor comprising a dual layer type photosensitive layer installed on a substrate in accordance with an embodiment of the present invention.

FIG. 3 is a schematic representation of an image forming apparatus, an electrophotgraphic drum, and an electrophographic cartridge in accordance with selected embodiments of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

An electrophotographic photoreceptor according to the present invention is now described in detail.

The present invention includes a photosensitive layer including a layer comprising a combination of a polyester resin having a specific structure and a hole transport material. it is evident that a photoreceptor using a polyester resin having a biphenyl fluorene backbone in a main chain, is poor in view of dark decay and sensitivity, compared to a photoreceptor using a polycarbonate resin, although reasons for the foregoing are not clear. However, it is thought that a large π electron conjugated system of the fluorene ring presumably interferes with a π electron conjugated system of a charge transport material associated with charge transport, resulting in a change in energy level. In the stilbene compounds used in the present invention for charge transporting, a stilbene backbone and an enamine backbone, both associated with charge transport, coexist in a flexibly coordinatable manner with a phenyl group interposed therebetween, so that the stilbene compounds are able to form a conformation readily in which the fluorene backbone is unlikely to interfere with the stilbene compounds, realizing effective electrical properties.

Various examples of an electrophotographic photoreceptor according to the present invention are now described.

The electrophotographic photoreceptor may have a photosensitive layer coated on an electrically conductive substrate. As the conductive substrate, a metal or plastic having a thin layer of an electrically conductive material, drum- or belt-shaped substrate may be used.

The photosensitive layer may be a dual layer type layer in which a charge generating layer and a charge transport layer are separately laminated, or a single layer type having both charge generating and transporting functions.

Examples of the charge generating material used for the photosensitive layer include organic materials such as phthalocyanine pigments, azo pigments, quinone pigments, perylene pigments, indigo-based pigments, bisbenzoimidazole pigments, quinacridone pigments, azulenium dyes, squarylium dyes, pyrylium dyes, triarylmethane dyes, cyanine dyes, and inorganic materials such as amorphous silicon, amorphous selenium, trigonal selenium, tellurium, selenium-tellurium alloys, cadmium sulfide, antimony sulfide or zinc sulfide. The charge generating materials are not limited to those listed herein, and may be used alone or in combination of two or more kinds of the materials.

In the dual layer type photoreceptor, the charge generating layer may be formed by dispersing a charge generating material and a binder resin in a solvent and coating the same, or may be formed by any of various known methods, including vacuum deposition, sputtering, or the chemical vapor deposition method (CVD). The charge generating layer generally has a thickness in the range of about 0.1 μm˜about 1.0 μm. If the thickness is less than about 0.1 um, the sensitivity is ineffective. If the thickness is greater than 1.0 μm, the charging capability and sensitivity are disadvantageously lowered.

Preferred examples of the binder resin for use in the charge generating layer include, but are not limited to, electrically insulating condensed polymers, for example, polycarbonates, polyesters, (meth)acrylic resins, polyvinyl chloride, polyvinylidene chloride, polystyrene, polyvinyl acetate, silicon resins, silicon-alkyd resins, styrene-alkyd resins, poly-N-vinylcarbazole, phenoxy resins, epoxy resins, polyvinyl butyral, polyvinyl acetal, polyvinyl formal, polysulfones, polyvinyl alcohol, ethyl cellulose, phenol resins, polyamide, carboxy-methyl cellulose and polyurethane. The condensed polymers may be used alone or in combination of two or more kinds of materials.

In the dual layer type photoreceptor, a charge transport layer having both a polyester resin and the stilbene compounds according to the present invention is laminated on a charge generating layer, but the structure may be reversed in a so-called inverted dual layer type photoreceptor such that a charge generating layer is formed on a charge transport layer. In forming the charge transport layer, coating of a solution obtained by dissolving the polyester resin and the stilbene compound in a solvent may be employed.

In the case of a single-layer type photoreceptor, a photosensitive layer may be prepared by dissolving the charge generating material, the charge transport material and the binder resin in a solvent and coating the resultant product. Then, as the binder resin and the charge transport material, the polyester resin and the stilbene compound may be used according to the present invention in combination. However, the stilbene compound has only a hole transport capability, and, in the case of a single-layer type photoreceptor in which charges are generated inside a photosensitive layer, electrons may remain on the layer and a residual potential may easily increase due to repetition of electrophotographical cycling. Thus, it is preferred to use a separate electron transport material as well.

The photosensitive layer generally has a thickness in the range of about 5 μm to about 50 μm, irrespective of whether it is of a single-layer type or dual-layer type. Examples of solvents used in the coating technique include organic solvents such as alcohols, ketones, amides, ethers, esters, sulfones, aromatics, aliphatic halogenated hydrocarbons and the like. Examples of the coating technique include a dip coating method, a ring coating method, a roll coating method or a spray coating method, but any coating technique may be applied to the electrophotographic photoreceptor according to the present invention.

In the photosensitive layer having a polyester resin having a biphenyl fluorene backbone in a main chain represented by Formula 1 and a stilbene compound represented by Formula 2, the polyester resin may be used singly as the binder resin or in combination with another resin within a range that does not adversely affect advantages of the present invention. In the latter case, the weight of the polyester resin according to the present invention contained in the binder resin mixture is preferably more than 50 wt % based on the total weight of the binder resin mixture.

Examples of the polyester binder resin according to the present invention include polyester resins represented by the following formulas:

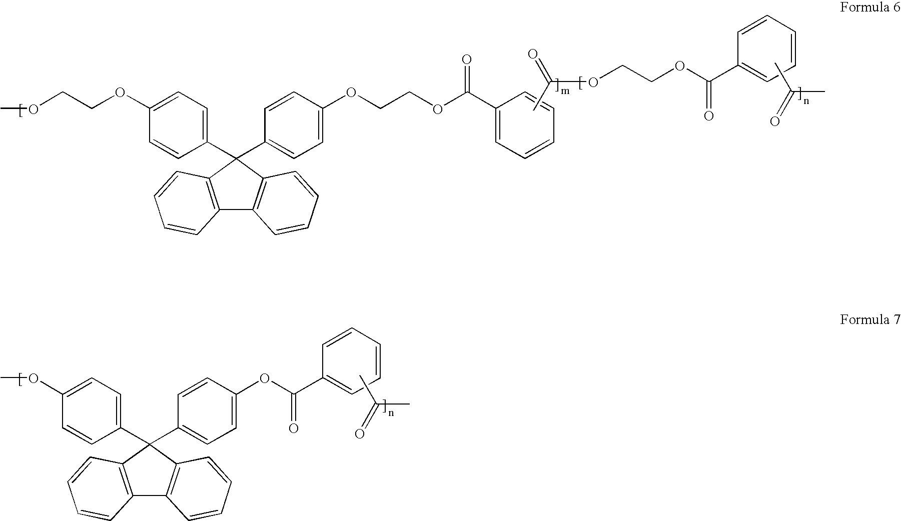

wherein m and n are independently an integer from 10˜1000. The polyester resins represented by Formulas 6 and 7 are commercially available (“O-PET” by KANEBO and “ISARYL” by ISONOVA, respectively).

The polyester resin for use in the electrophotographic photoreceptor according to the present invention is not limited to the resins mentioned herein, but, for example, polyester copolymer of one or more structural units having the biphenyl fluorene backbone represented by Formula 1 in the main chain and another structural unit may be used.

In the electrophotographic photoreceptor of the present invention, the stilbene compounds represented by Formula 2 may be used as the hole transport material. Examples of the hole transport material suitably used for the electrophotographic photoreceptor are represented by:

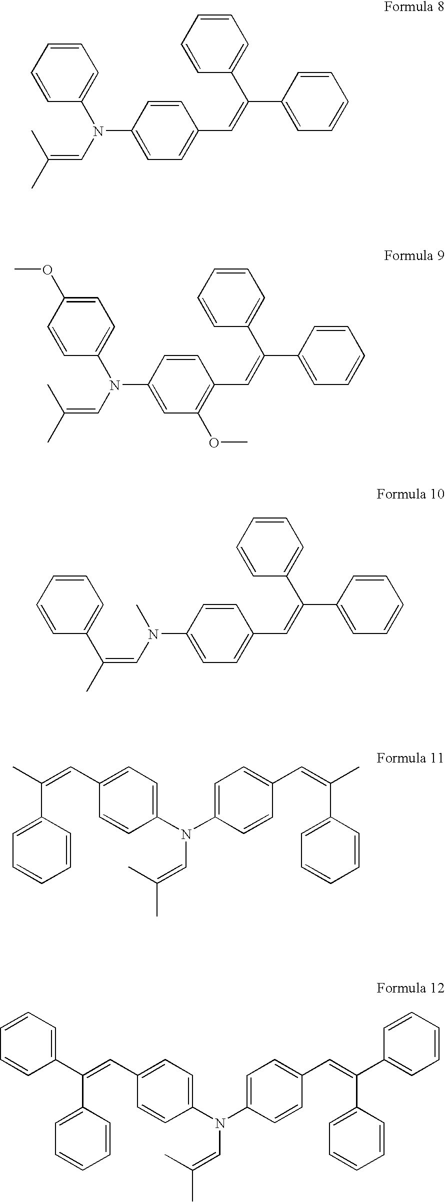

The stilbene compounds represented by Formulas 8˜12 are disclosed in U.S. Pat. No. 5,013,623, and may be easily prepared by the processes as disclosed in the same patent.

Also, the photosensitive layer may further include other charge transport materials within the range in which the effects of the present invention are not adversely affected. As the charge transport material, a hole transport material and an electron transport material may be used. In particular, in the case of a single-layer type photoreceptor, the electron transport material is also preferably added.

Examples of the hole transport material that may be further added include nitrogen-containing cyclic compounds or condensed polycyclic compounds such as pyrene compounds, carbazole compounds, hydrazone compounds, oxazole compounds, oxadiazole compounds, pyrazoline compounds, arylamine compound, arylmethane compounds, benzidine compounds, thiazole compounds or styryl compounds. Such materials may be used alone or in combinations thereof. Polymer compounds or polysilane compounds having such substituents in the main chains or side chains may also be used.

Examples of the electron transport material that may be further added include electron attracting low-molecular weight compounds such as benzoquinone compounds, cyanoethylene compounds, cyanoquinodimethane compounds, fluorolenone compounds, xantone compounds, phenantraquinone compounds, phthalic anhydride-based compounds, thiopyrane comounds or diphenoquinone compounds, but are not limited thereto. Electron transporting polymer compounds or pigments having n-type semiconducting characteristics may also be used.

The charge transport material that may be used with the electrophotographic photoreceptor according to the present invention is not limited to the materials listed herein, and such materials may be used alone or in combination thereof.

It is preferable that the amount of the stilbene compound be in the range of about 10˜60 parts by weight based on the weight of the photosensitive layer. If the amount of the stilbene compound is less than 10 parts by weight, an insufficient hole transporting capability results so that the sensitivity is low, and the residual potential increases. If the amount of the stilbene compound is greater than 60 parts by weight, the relative amount of the binder resin contained in the photosensitive layer is so small that advantageous properties of the polyester resin of the present invention are not sufficiently exerted.

Alternatively, an intermediate layer may be installed between the electrically conductive substrate and a photosensitive layer to enhance adhesion or prevent charges from being injected from the substrate. Examples of the intermediate layer include, but are not limited to, an aluminum anodic oxidation layer, a resin layer dispersed with metal oxide powder such as titanium oxide or tin oxide, and a resin layer such as polyvinyl alcohol, casein, ethylcellulose, gelatin, phenol resins or polyamides.

Also, the photosensitive layer may contain a plasticizer, a leveling agent, a dispersion-stabilizing agent, an antioxidant or a photo-stabilizing agent in addition to the binder resin.

Examples of the antioxidant include phenol compounds, sulfur compounds, phosphorus compounds or amine compounds.

Examples of the photo-stabilizing agent include benzotriazol compounds, benzophenone compounds, or hindered amine compounds.

### EXAMPLES

### Example 1

3 parts by weight of γ-titanyl phthalocyanine was added to a solution obtained by dissolving 50 parts by weight of a polyester resin (O-PET, KANEBO) represented by Formula 6, 40 parts by weight of a hole transport material represented by Formula 8 and 10 parts by weight of an electron transport material represented by the following formula 13 in 300 parts by weight chloroform, and dispersed using a ball mill to give a coating solution.

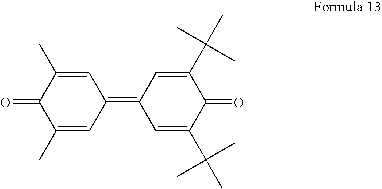

Next, the resulting coating solution was coated on an aluminum drum having a diameter of 30 μm by a ring coating method, and dried to obtain a 20 μm thick, single-layer type electrophotographic photoreceptor.

### Comparative Example 1

An electrophotographic photoreceptor was formed in the same manner as in Example 1, except that a polycarbonate resin (Panlite C-1400, TEIJIN CHEMICALS LTD.) was used instead of the polyester resin represented by Formula 6.

### Comparative Example 2

An electrophotographic photoreceptor was formed in the same manner as in Example 1, except that a hole transport material represented by Formula 14 was used instead of the stilbene compound represented by Formula 8.

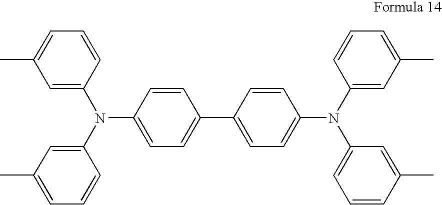

An electrophotographic photoreceptor was formed in the same manner as in Comparative Example 1, except that a hole transport material represented by Formula 14 was used instead of the stilbene compound represented by Formula 8.

### Example 2

A coating solution prepared by dispersing 7 parts by weight of γ-titanyl phthalocyanine, 3 parts by weight of a polyvinyl butyral resin (S-LEC BH-3, SEKISUI CO., Japan) and 290 parts by weight of ethyl acetate in a sand mill, was coated on an aluminium drum which is the same as that used in Example 1 by a ring coating method, and dried to form a charge generating layer having a thickness of 0.4 μm.

Next, a solution prepared by dissolving 60 parts by weight of a polyester resin represented by Formula 7 (ISARYL 25L, ISONOVA), 40 parts by weight of a hole transport material represented by Formula 11 in 300 parts by weight of chloroform, was coated on the charge generating layer to form a charge transport layer having a thickness of 20 μm, giving a dual-layer type electrophotographic photoreceptor.

### Comparative Example 4

An electrophotographic photoreceptor was formed in the same manner as in Example 2, except that a polycarbonate resin (lupilion Z-200, MITSUBISHI CHEMICAL CO., Japan) was used instead of the polyester resin represented by Formula 7.

### Comparative Example 5

An electrophotographic photoreceptor was formed in the same manner as in Example 2, except that a hole transport material represented by Formula 15 was used instead of the stilbene compound represented by Formula 11.

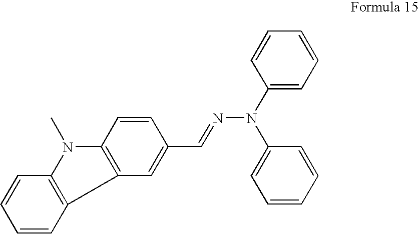

### Comparative Example 6

An electrophotographic photoreceptor was formed in the same manner as in Comparative Example 4, except that a hole transport material represented by Formula 15 was used instead of the stilbene compound represented by Formula 11.

Performances of the electrophotographic photoreceptors prepared in Examples 1˜2 and Comparative Examples 1˜6 were evaluated by the following methods.

### Electrostatic Properties

Electrophotographic performances of the photoreceptors were measured using a drum photoreceptor evaluation apparatus (PDT-2000 manufactured by QEA).

Measuring conditions are as follows.

A corona voltage +7.5 kV was applied to single-layer type photoreceptors and −7.5 kV was applied to dual-layer type photoreceptors, both charged with a relative speed of a charger and the photoreceptor being 100 mm/sec, immediately followed by irradiating monochrome light having a wavelength of 780 nm at a constant exposure energy in the range between 0 and 10 mJ/m². Then, surface potential values after exposure were recorded and the relationship between the exposure energy and surface potential was investigated.

Here, the potential retention rate was set to a ratio of a surface potential without light irradiation being V₀(V) to a potential after 1 second at a dark place being V₁(V), that is, V₁/V₀. Energy required for V₀ decaying to a half by irradiation is denoted by E_{1/2}(mJ/m²). For evaluation of stability, properties of each photoreceptor were measured after repeating 100 cycles of charging under the same conditions as described above and discharging by exposure using a 600 nm LED (energy for discharging: approximately 100 mJ/m²) 1 second after the charging. The measurement results are shown in Table 1.

TABLE 1

| | V₀(V) | | V₁/V₀(%) | | E_{1/2}(mJ/m²) | |
|---|---|---|---|---|---|---|
| Sample | Initial | After test | Initial | After test | Initial | After test |
| Example 1 | 608 | 601 | 97 | 95 | 1.62 | 1.65 |
| Comparative | 616 | 605 | 98 | 95 | 1.54 | 1.60 |
| Example 1 | | | | | | |
| Comparative | 603 | 575 | 90 | 82 | 1.81 | 2.37 |
| Example 2 | | | | | | |
| Comparative | 611 | 602 | 96 | 92 | 1.75 | 1.84 |
| Example 3 | | | | | | |
| Example 2 | −708 | −713 | 97 | 95 | 1.18 | 1.21 |
| Comparative | −712 | −715 | 98 | 95 | 1.14 | 1.20 |
| Example 4 | | | | | | |
| Comparative | −663 | −641 | 87 | 81 | 1.36 | 1.54 |
| Example 5 | | | | | | |
| Comparative | | | | | | |
| Example 6 | −710 | −721 | 97 | 93 | 1.25 | 1.33 |

Durability test
(1) Adhesiveness

### Durability Test

(1) Adhesiveness

To evaluate adhesiveness between single-layered photoreceptors prepared in Example 1 and Comparative Examples 1˜3, a peeling test was carried out using adhesive tapes. The evaluation method was performed in such a manner that a 10 cm long adhesive tape (“SCOTCH TAPE #104”, manufactured by 3M) was applied onto the surface of a photosensitive layer of the photoreceptors from an end of the photosensitive layer in an axial direction of a drum, and the tape was slowly peeled off from the end in a direction perpendicular to the drum.

As a result, the photoreceptors prepared in Example 1 and Comparative Example 2 in which the polyester resin was used showed no peeling of the photosensitive layer at all. In contrast, the photoreceptors prepared in Comparative Examples 1 and 3, in which a general polycarbonate resin was used, showed peeling-off of the photosensitive layer from the substrate throughout the adhered surface of the tape.

(2) Abrasion Resistance

The respective dual layer type photoreceptors prepared in Example 2 and Comparative Examples 4˜6 were mounted on an in-house tester made by modifying a laser printer (ML-6060, manufactured by Samsung Electronics). The abrasion resistance was evaluated in such a manner that while supplying toner, after 10,000 test sheets were printed using a test image with 5% concentration, a change in photosensitive layer thickness, that is, a difference between an initial thickness and a thickness after abrasion resistance test, was measured. The measurement results are shown in Table 2.

TABLE 2

| | | Comparative | Comparative | Comparative |
|---|---|---|---|---|
| Photoreceptor | Example 2 | Example 4 | Example 5 | Example 6 |
| Change in lay- | 0.8 | 1.5 | 0.9 | 1.7 |
| er thickness | | | | |
| (μm) | | | | |

In Table 1, as is clear from the comparison between the photoreceptors prepared in Comparative Examples 2 and 3 and between those prepared in Comparative Examples 5 and 6, when a general hole transport material is combined with a general polycarbonate resin, an electrophotographic photoreceptor exhibits good electrophotographic characteristics. However, when the general hole transport material is combined with polyester resin having a biphenyl fluorene backbone in a main chain, the dark decay and sensitivity thereof are considerably deteriorated. In contrast, as is clear from the comparison between the photoreceptors prepared in Example 1 and Comparative Example 1, and between the photoreceptors prepared in Example 2 and Comparative Example 4, the photoreceptor using the stilbene compound according to the present invention has substantially the same characteristics as the charateristics of the photoreceptor using a polycarbonate resin.

Also, as is clear from the durability test results, the conventional photoreceptors prepared in Comparative Examples using a polycarbonate resin are ineffective in adhesion to a substrate and abrasion resistance. On the other hand, the photoreceptors according to the present invention using the polyester resin having a biphenyl fluorene backbone in a main chain as a binder resin have effective characteristics in every respect.

Therefore, according to the test results of electrostatic properties and durability, the photoreceptors according to Examples 1 and 2 of the present invention have both effective electrostatic and mechanical properties.

As described above, the electrophotographic photoreceptor according to the present invention has effective electrostatic properties and high mechanical strength.

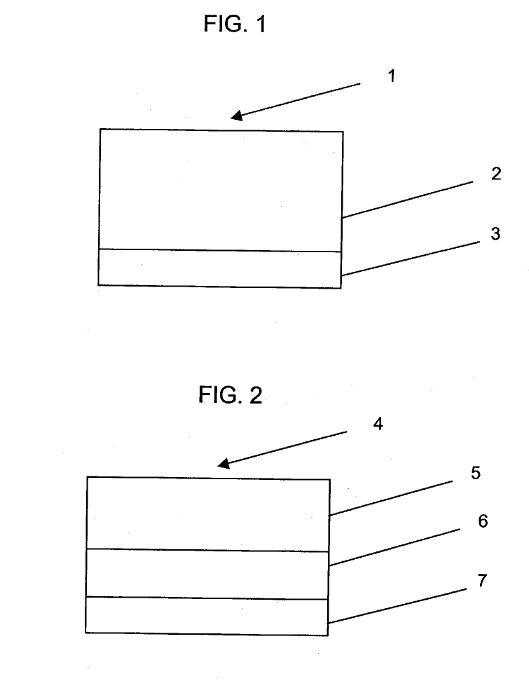

FIG. 1 is a block diagram illustrating (not to scale) an electrophotographic photoreceptor 1 comprising a single layer type photosensitive layer 2 installed on a substrate 3 in accordance with an embodiment of the present invention.

FIG. 2 is a block diagram illustrating (not to scale) an electrophotographic photoreceptor 4 comprising a dual layer type photosensitive layer 5, 6 installed on a substrate 7 in accordance with an embodiment of the present invention.

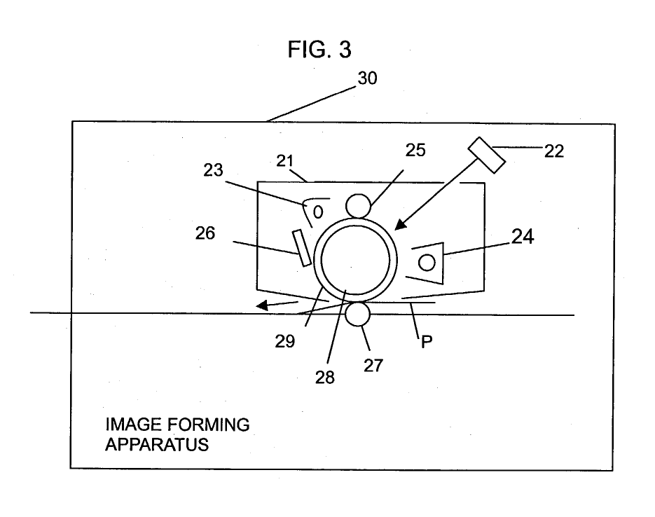

FIG. 3 is a schematic representation of an image forming apparatus 30, an electrophotgraphic drum 28, and an electrophographic cartridge 21 in accordance with selected embodiments of the present invention. The electrophotographic cartridge 21 typically comprises an electrophotographic photoreceptor 29 and at least one of a charging device 25 that charges the electrophotographic photoreceptor 29, a developing device 24 which develops an electrostatic latent image formed on the electrophotographic photoreceptor 29, and a cleaning device 26 which cleans a surface of the electrophotographic photoreceptor 29. The electrophotographic cartridge 21 may be attached to or detached from the image forming apparatus 30, and the electrophotographic photoreceptor 29 is described more fully above.

The electrophotographic photoreceptor drum 28, 29 for an image forming apparatus 30, generally includes a drum 28 that is attachable to and detachable from the electrophotographic apparatus 30 and that includes an electrophotographic photoreceptor 29 disposed on the drum 28, wherein the electrophotographic photoreceptor 29 is described more fully above.

Generally, the image forming apparatus 30 includes a photoreceptor unit (e.g., an electrophotographic photoreceptor drum 28, 29), a charging device 25 which charges the photoreceptor unit, an imagewise light irradiating device 22 which irradiates the charged photoreceptor unit with imagewise light to form an electrostatic latent image on the photoreceptor unit, a developing unit 24 that develops the electrostatic latent image with a toner to form a toner image on the photoreceptor unit, and a transfer device 27 which transfers the toner image onto a receiving material, such as paper P, wherein the photoreceptor unit comprises an electrophotographic photoreceptor 29 as described in greater detail above. The charging device 25 may be supplied with a voltage as a charging unit and may contact and charge the electrophotographic receptor. Where desired, the apparatus may include a pre-exposure unit 23 to erase residual charge on the surface of the electrophotographic photoreceptor to prepare for a next cycle.

Where desired, the photoreceptor may have a protective layer disposed thereon (not shown).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrophotographic photoreceptor comprising a photosensitive layer including a layer comprising at least one of a binder resin comprising a polymer compound and a hole transport material comprising a low-molecular weight compound, on an electrically conductive substrate, wherein the polymer compound is a polyester resin having a biphenylfluorene unit represented by Formula 1 in a main chain, and the low-molecular weight compound is a stilbene compound represented by Formula 2: 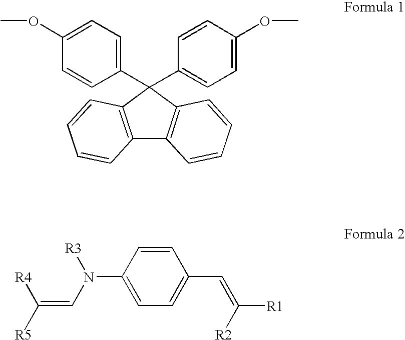
wherein in Formula 1, a hydrogen atom of an aromatic ring is optionally substituted by an arbitrary substituent; and in Formula 2, R1 through R5 are independently selected from the group consisting of a hydrogen atom, a C1˜C30 substituted or unsubstituted alkyl group, a C6˜C30 substituted or unsubstituted aryl group, a C1˜C30 substituted or unsubstituted alkoxy group, and a C8˜C30 substituted or unsubstituted styryl group, and the hydrogen atom in the aromatic ring is optionally substituted by an arbitrary substituent.

2. The electrophotographic photoreceptor of claim 1, wherein the photosensitive layer has a dual layer structure of a charge generating layer and a charge transport layer that includes a binder resin and a hole transport material.

3. The electrophotographic photoreceptor of claim 1, wherein the layer containing the binder resin and the hole transport material further includes a charge generating material.

4. The electrophotographic photoreceptor of claim 1, wherein the layer containing the binder resin and the hole transport material further includes an electron transport material.

5. The electrophotographic photoreceptor of claim 1, wherein the polyester resin is a copolymer having at least two structural units selected from the following units represented by Formulas 3, 4 and 5:

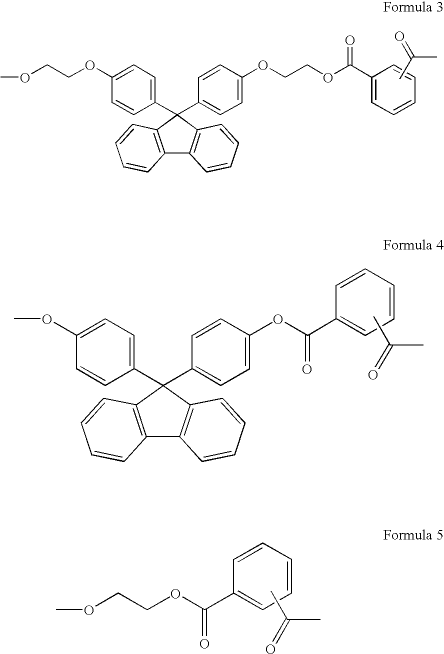

6. The electrophotographic photoreceptor of claim 1, wherein the proportion of the stilbene compound in the photosensitive layer is in the range of 10˜60 parts by weight.

7. An electrophotographic imaging apparatus comprising:
a plurality of support rollers; and
an electrophotographic photoreceptor operably coupled to the support rollers with motion of the support rollers resulting in motion of the electrophotographic photoreceptor, the electrophotographic photoreceptor comprising a photosensitive layer including a layer comprising at least one of a binder resin made of a polymer compound and a hole transport material made of a low-molecular weight compound, on an electrically conductive substrate, wherein the polymer compound is a polyester resin having biphenylfluorene unit represented by Formula 1 in a main chain, and the low-molecular weight compound is a stilbene compound represented by Formula 2: 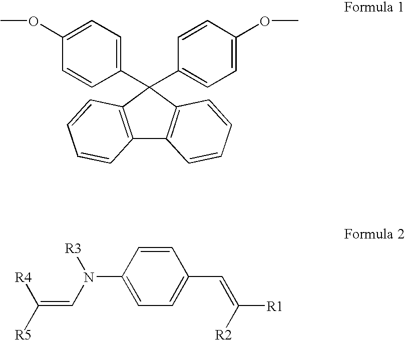
wherein in Formula 1, a hydrogen atom of an aromatic ring is optionally substituted by an arbitrary substituent; and in Formula 2, R1 through R5 are independently selected from the group consisting of a hydrogen atom, a C1˜C30 substituted or unsubstituted alkyl group, a C6˜C30 substituted or unsubstituted aryl group, a C1˜C30 substituted or unsubstituted alkoxy group, and a C8˜C30 substituted or unsubstituted styryl group, and the hydrogen atom in the aromatic ring is optionally substituted by an arbitrary substituent.

8. The electrophotographic imaging apparatus of claim 7, wherein the photosensitive layer has a dual layer structure of a charge transport layer containing a binder resin and a hole transport material and a charge generating layer.

9. The electrophotographic imaging apparatus of claim 7, wherein the layer containing the binder resin and the hole transport material further includes a charge generating material.

10. The electrophotographic imaging apparatus of claim 7, wherein the layer containing the binder resin and the hole transport material further includes an electron transport material.

11. The electrophotographic imaging apparatus of claim 7, wherein the polyester resin is a copolymer having at least two structural units selected from the following units represented by Formulas 3, 4 and 5:

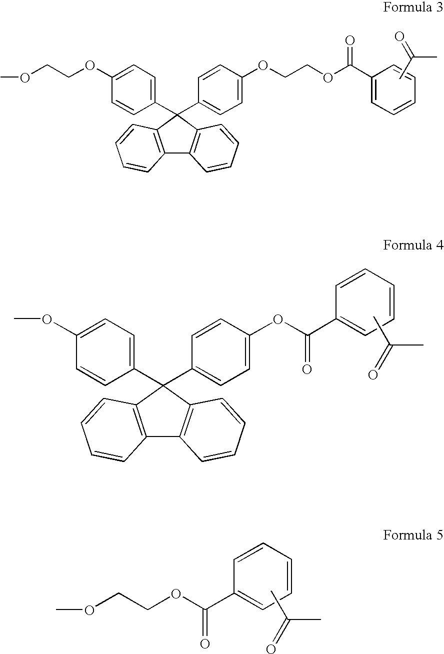

12. The electrophotographic imaging apparatus of claim 7, wherein the proportion of the stilbene compound in the photosensitive layer is in the range of 10˜60 parts by weight.

13. An electrophotographic cartridge, comprising:
an electrophotographic photoreceptor comprising a photosensitive layer including a layer comprising at least one of a binder resin comprising a polymer compound and a hole transport material comprising a low-molecular weight compound, on an electrically conductive substrate, wherein the polymer compound is a polyester resin having a biphenylfluorene unit represented by Formula 1 in a main chain, and the low-molecular weight compound is a stilbene compound represented by Formula 2: 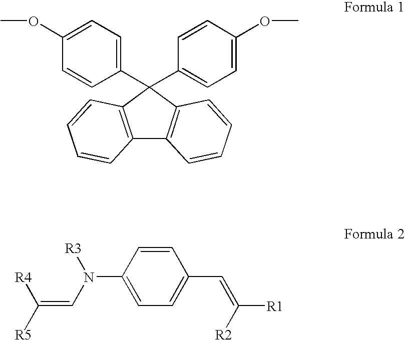
wherein in Formula 1, a hydrogen atom of an aromatic ring is optionally substituted by an arbitrary substituent; and in Formula 2, R1 through R5 are independently selected from the group consisting of a hydrogen atom, a C1˜C30 optionally substituted alkyl group, a C6˜C30 optionally substituted or aryl group, a C1˜C30 optionally substituted alkoxy group, and a C8˜C30 optionally substituted styryl group, and the hydrogen atom in the aromatic ring is optionally substituted by an arbitrary substituent; and
at least one of:
a charging device that charges the electrophotographic photoreceptor;
a developing device which develops an electrostatic latent image formed on the electrophotographic photoreceptor; and
a cleaning device which cleans a surface of the electrophotographic photoreceptor,
wherein the electrophotographic cartridge is attachable to/detachable from attached to an image forming apparatus.

14. The electrophotographic cartridge of claim 13, wherein the photosensitive layer of the electrophotoreceptor is one of:
a single layer type; and
a dual layer type.

15. An electrophotographic drum, comprising:
a drum that is attachable to and detachable from an electrophotographic apparatus; and
an electrophotographic photoreceptor, disposed on the drum, the electrophotographic photoreceptor comprising:
a photosensitive layer including a layer comprising at least one of a binder resin comprising a polymer compound and a hole transport material comprising a low-molecular weight compound, on an electrically conductive substrate, wherein the polymer compound is a polyester resin having a biphenylfluorene unit represented by Formula 1 in a main chain, and the low-molecular weight compound is a stilbene compound represented by Formula 2: 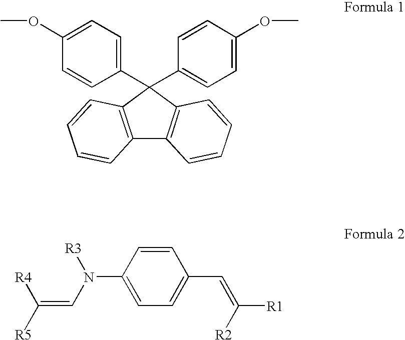
wherein in Formula 1, a hydrogen atom of an aromatic ring is optionally substituted by an arbitrary substituent; and in Formula 2, R1 through R5 are independently selected from the group consisting of a hydrogen atom, a C1˜C30 optionally substituted alkyl group, a C6˜C30 optionally substituted or aryl group, a C1˜C30 optionally substituted alkoxy group, and a C8˜C30 optionally substituted styryl group, and the hydrogen atom in the aromatic ring is optionally substituted by an arbitrary substituent.

16. The electrophotographic drum of claim 15, wherein the photosensitive layer of the electrophotoreceptor is one of:
a single layer type; and
a dual layer type.

17. An image forming apparatus comprising:
a photoreceptor unit comprising:
an electrophotographic photoreceptor comprising:
a photosensitive layer including a layer comprising at least one of a binder resin comprising a polymer compound and a hole transport material comprising a low-molecular weight compound, on an electrically conductive substrate, wherein the polymer compound is a polyester resin having a biphenylfluorene unit represented by Formula 1 in a main chain, and the low-molecular weight compound is a stilbene compound represented by Formula 2: 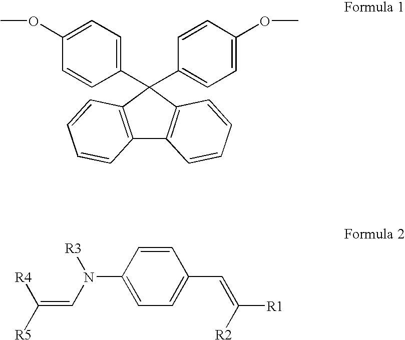
wherein in Formula 1, a hydrogen atom of an aromatic ring is optionally substituted by an arbitrary substituent; and in Formula 2, R1 through R5 are independently selected from the group consisting of a hydrogen atom, a C1˜C30 optionally substituted alkyl group, a C6˜C30 optionally substituted or aryl group, a C1˜C30 optionally substituted alkoxy group, and a C8˜C30 optionally substituted styryl group, and the hydrogen atom in the aromatic ring is optionally substituted by an arbitrary substituent;
a charging device which charges the photoreceptor unit;
an imagewise light irradiating device which irradiates the charged photoreceptor unit with imagewise light to form an electrostatic latent image on the photoreceptor unit;
a developing unit that develops the electrostatic latent image with a toner to form a toner image on the photoreceptor unit; and
a transfer device which transfers the toner image onto a receiving material.

18. The image forming apparatus of claim 17, wherein the photosensitive layer of the electrophotoreceptor is one of:
a single layer type; and
a dual layer type.
